(19) United States
(12) Patent Application Publication
(10) Pub. No.: US 2009/0013185 A1
(43) Pub. Date: Jan. 8, 2009

(54) COMPATIBLE SYSTEM OF DIGITAL RIGHTS MANAGEMENT AND METHOD FOR OPERATING THE SAME

(76) Inventor: Ji Hyun Lim, Suwon-si (KR)

Correspondence Address: MORGAN, LEWIS & BOCKIUS LLP (SF), One Market, Spear Street Tower, Suite 2800, San Francisco, CA, 94105, US

(21) Appl. No.: 11/971,618

(22) Filed: Jan. 9, 2008

(30) Foreign Application Priority Data
Jul. 6, 2007 (KR) 10-2007-0068253

(51) Int. Cl. H04L 9/32

(52) U.S. Cl. 713/170

(57) ABSTRACT

Disclosed is a compatible system of digital rights management which enables the reproduction of the same contents between apparatuses each employing a different digital rights management system. The compatible system of digital rights management comprises: a user server including a first authentication document of a first apparatus; a second apparatus connected to the first apparatus and outputting a contents request signal and a second authentication document to reproduce substantially the same contents; and a provider server forming a virtual safe channel with the user server based on the contents request signal to receive the first authentication document, and generating first and second licenses encrypted through the first and second authentication documents to transmit the same to the second apparatus.

This application claims the benefit of Korean Patent Application No. 10-2007-0068253, filed Jul. 6, 2007 in the Korean Intellectual Property Office, the disclosure of which is incorporated herein by reference.

### BACKGROUND OF THE INVENTION

1. Field of the Invention

The present invention relates to a compatible system of digital rights management and a method for operating the same, and more particularly, to a compatible system of digital rights management, which enables the reproduction of the same contents between apparatuses each employing a different digital rights management system, and a method for operating the same.

2. Discussion of the Related Art

Generally, audio/video and various types of contents provided via various types of wired and wireless communications networks, such as the Internet and wireless communications, or via networks, such as a broadcasting network, are only executable by digital rights management (DRM) servers supporting the copyright management of the corresponding contents format.

At present, with a variety of DRM servers being widely distributed, all the DRM servers do not provide sufficient compatibility of contents, and contents as well do not comply with one standard and thus limits the use of contents by a user.

However, as even the apparatuses used by the same user uses a different DRM system, the use of contents is limited, depending on each DRM system, and there occurs a difficulty in compatibility of contents between different DRM apparatuses.

For example, in order to make contents compatible, there is the inconvenience that a first DRM system server has to convert contents according to a second DRM system for supplying the contents. Furthermore, it is difficult to provide an intrinsic interface between different DRM system servers.

Accordingly, in recent years, there have been studies on a system and method for improving compatibility between apparatuses and servers employing different DRM systems.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

A compatible system of digital rights management in accordance with the present invention comprises; a user server including a first authentication document transmitted from a first apparatus; a second apparatus connected to the first apparatus and outputting a contents request signal and a second authentication document to reproduce substantially the same contents as the first apparatus; and a provider server forming a virtual safe channel with the user server based on the contents request signal to receive the first authentication document from the user server, and generating first and second licenses encrypted through the first and second authentication documents to transmit the same to the second apparatus.

Additionally, a method for operating a compatible system of digital rights management in accordance with the present invention comprises the steps of: transmitting a second authentication document and a contents request signal to a provider server from a second apparatus via a network; forming a virtual safe channel between a user server and the provider server based on the contents request signal; transmitting a first authentication document of a first apparatus to the provider server from the user server via the formed virtual safe channel; and generating first and second licenses from the provider server based on the first and second authentication documents and transmitting the first license and same contents to the first apparatus.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic system view showing a compatible system of digital rights management in accordance with an exemplary embodiment of the present invention; and

FIG. 2 is a sequence view showing a method for operating a compatible system of digital rights management in accordance with an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

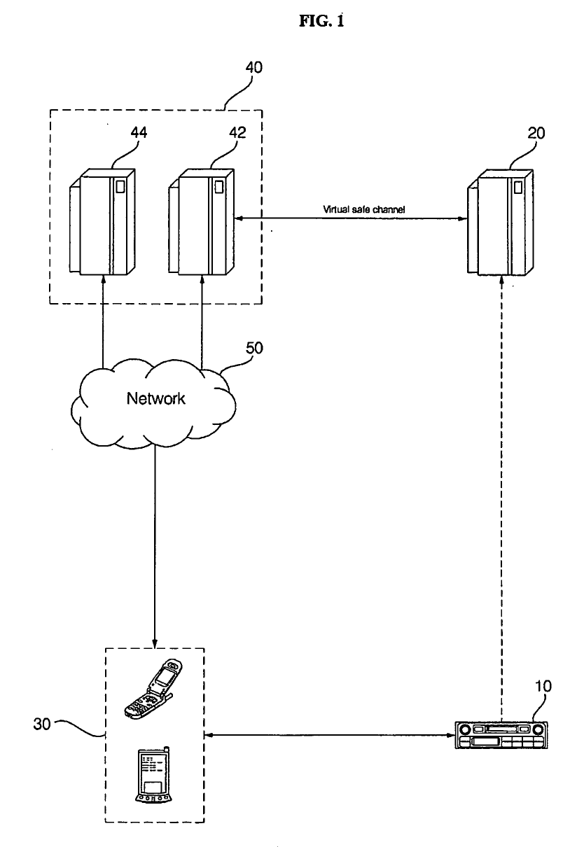

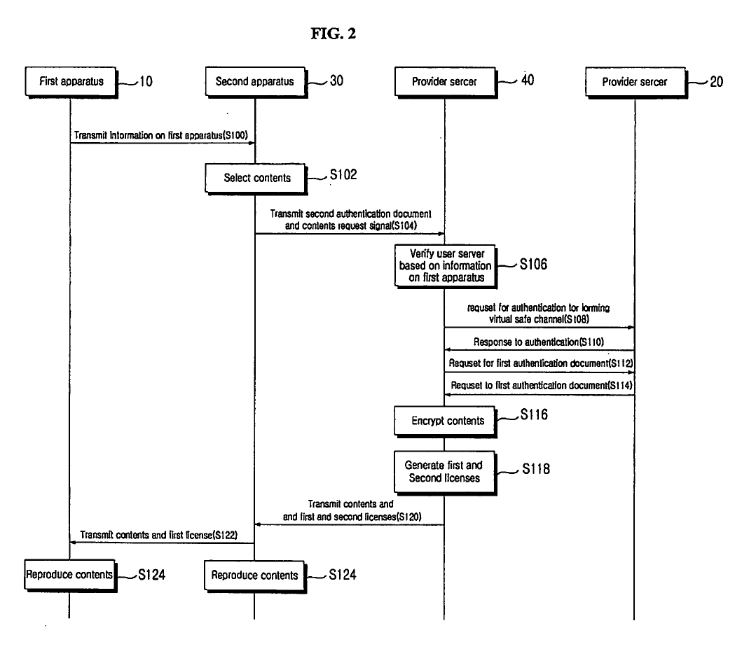

Hereinafter, a preferred embodiment of the present invention will be described with reference to FIGS. 1 and 2.

FIG. 1 is a schematic system view showing a compatible system of digital rights management in accordance with an exemplary embodiment of the present invention.

Referring to FIG. 1, the compatible system of digital rights management in accordance with an exemplary embodiment of the present invention includes a first apparatus 10, a user server 20 for storing a first authentication document of the first apparatus 10, a second apparatus 30 for selecting one of different contents and reproducing the same, and a provider server 40 comprising a contents storage server 44 and a object management server 42.

Here, the first apparatus 10 may be operated in connection with another external apparatus to reproduce the contents. That is, the first apparatus 10 is an apparatus which is connected to the second apparatus 30 to reproduce the contents that are reproduced in the second apparatus 30, and which is not directly connected to the provider server 40 and a network 50.

The user server 20 stores the first authentication document transmitted from the first apparatus 10, and when the first authentication document of the first apparatus 10 is requested by the provider server 40 via a virtual safe channel formed between the provider server 40 and the user server 20 upon receipt of a contents request signal to the provider server 40 from the second apparatus 30 which is operating in connection with the first apparatus 10, the user server 20 transmits the first authentication document to the provider server 40.

The second apparatus 30 transmits the contents request signal and a second authentication document to the provider server 40 via the network 50. In other words, if the second apparatus 30 operates in connection with the first apparatus 10, it transmits the contents request signal containing information on the first apparatus 10 and information on the contents selected from the second apparatus to the provider server 40 via the network 50.

Here, the second apparatus 30 is at least one of a mobile communication terminal, a navigation device, and a video player that connect the provider server 40 via the network 50, and works together with the first apparatus 10.

After receiving the contents request signal and the second authentication document, the provider server 40 forms a virtual safe channel with the user server 20 based on the contents request signal transmitted from the second apparatus 30.

That is, the provider server 40 verifies the user server 20 having the first authentication document of the first apparatus 10 by determining whether the user server 20 is reliable based on the information on the first apparatus 10 contained in the contents request signal.

At this time, the provider server 40 performs a PKI (public key infrastructure)-based mutual authentication with the user server 20, thereby ensuring the mutual reliability between the servers 20 and 40.

After verification, the provider server 40 makes a request to the user server 30 for transmitting the first authentication document stored in the first apparatus 10 via a virtual safe channel formed between the provider server 40 and the user server 20 transmits the first authentication document to the provider server 40.

The provider server 40 includes an object management server 42 for generating the first and second licenses through the received first authentication documents from the user server 30 and the second authentication documents and transmitting them to the second apparatus 30; and a contents storage server 44 for transmitting the contents to the second apparatus 30 via network 50.

The object management sever 42 transmits the first and second licenses encrypted with encryption keys contained in the first and second authentication documents, respectively, to the second apparatus 30.

Finally, the second apparatus 30 receives first and second licenses containing the contents and the copyright to the contents from the provider server 40 via the network 50. Then, the second apparatus 30 transmits the contents to be reproduced in the first apparatus 10 and the first license to the first apparatus 10.

The first and second apparatuses 10 and 30 encodes the contents by respective encoding keys contained in the first and second authentication documents, in order to reproduce the contents, and then reproduce the same contents through the respective first and second licenses.

The first and second apparatuses 10 and 30 may be connected to a USB cable or a data transmission cable as may be selected by a person of ordinary skill in the art based on the teachings herein.

Here, the encryption of the contents is performed under DES, SHA, RC4, MAC, Seed, etc. that are generally used by a person of ordinary skill in the art based on the teachings herein, and the encryption algorithms are not limited thereto.

FIG. 2 is a sequence view showing a method for operating a compatible system of digital rights management in accordance with an exemplary embodiment of the present invention.

Referring to FIG. 2, in the method for operating a compatible system of digital rights management in accordance with an exemplary embodiment of the present invention, when a first apparatus 10 and a second apparatus 30 are connected via USB cable or a data transmission cable, information on the first apparatus 10 is transmitted to the second apparatus (S100). When the second apparatus 30 selects contents (S102), a contents request signal containing information on the first apparatus 10 and information on the contents are transmitted to a provider server 40 via the network 50 (S104).

In other words, after the second apparatus 30 is connected to the first apparatus 10, the second apparatus 30 selects the contents for reproducing the contents in the first apparatus 10 and transmits a contents request signal to the provider server 40 through the network 50.

Once the contents request signal of the second apparatus 30 is transmitted to the provider server 40 from the second apparatus 30, the provider server 40 verifies the user server 20 based on the information on the first apparatus 10 contained in the contents request signal (S106), requests the user server 20 for authentication to form a mutual virtual safe channel (S108), and the user server 20 responses to the request for the authentication transmitted from the provider server 40 (S110).

In other words, the provider server 40 verifies the user server 20 having the first authentication document of the first apparatus 10 stored therein based on the information on the first apparatus 10 contained in the contents request signal.

At this time, the provider server 40 performs a separate PKI (Public key Infrastructure)-based mutual authentication with the user server 20 in order to form a virtual safe channel with the user server 20, thereby ensuring the mutual reliability between the servers 40 and 20.

Here, the procedure of authentication of the provider server 40 and the user server 20 for the formation of a virtual safe channel will be described below in detail as an exemplary embodiment.

The provider server 40 transmits an authentication request signal HELLO to the user server 20 in order to authenticate a rights object server, i.e., the object management server 42 between them.

Here, the authentication request signal HELLO represents general information for description, and its format employs a general password verification algorithm as may be selected by a person of ordinary skill in the art based on the teachings herein.

That is, the authentication request signal HELLO has to contain at least one individual information for the safety and reliability of the provider server 40 and the user server 20, and the user server 20 verifies the provider server 40 based on the at least one individual information contained in the authentication request signal HELLO transmitted from the provider server 40, and transmits an authentication verification signal HELLO to the provider server 40.

In this way, once authentication verification is completed, the provider server 40 and the user server 30 transmit an RI intrinsic value of the rights object server 42 to execute the authentication of the rights object server 42 between them.

Accordingly, when the authentication of the rights object server 42 is completed, the virtual safe channel is formed.

After the virtual safe channel with the user server 20 is formed, the provider server 40 requests for the first authentication document (S112) stored in the user server 20 and receives the first authentication document from the user server 20 (S114).

In other words, when the mutual authentication is completed and the virtual safe channel is formed at the stage of S108 and S110, the provider server 40 requests the user server 20 for the first authentication document of the first apparatus 10. Then, the user server 20 transmits to the provider server 40 the stored first authentication document according to the provider server 40's request for the first authentication document at the stage of S112 and S114.

Once the first authentication document is transmitted to the provider server 40, each of the contents is encrypted based on the encryption keys contained in the respective first and second authentication documents (S116), and the first and second licenses are generated by the object management server 42 of the provider server 40 (S118).

In other words, the object management server 42 of the provider server 40 encrypts each of the contents to be reproduced in the first and second apparatuses 10 and 30 by the respective encryption keys contained in the first and second authentication documents.

Here, each of the contents to be transmitted to the first and second apparatuses 10 and 30 and reproduced is differently encrypted by their respective digital rights management.

Further, the object management server 42 of the provider server 40 encrypts and generates the first and second licenses containing information on the contents by the encryption keys contained in the first and second authentication documents. The first and second licenses may include the contents and the copyright to the contents.

The first and second apparatuses 10 and 30 that encode the first and second licenses stores their encryption keys differently in the first and second authentication documents, and the encryption keys are not compatible.

The provider server 40 transmits the first and second licenses and the contents to the second apparatus (S120), and then the second apparatus 30 transmits the first license and the contents to the first apparatus 10 (S122).

The first and second apparatuses 10 and 30 enables to reproduce the same contents by using the first and second licenses respectively, even though each apparatus employs different digital rights management system, and thus increases the compatibility of the contents between different DRM apparatus.

The compatible system of digital rights management has the advantage of reproducing contents by another apparatus desired even under a different digital rights management system by working together with the audio system of a car and a mobile communication terminal, receiving a license from the provider server providing MP3 music to the mobile communication terminal and reproducing the same MP3 music.

Although the present invention has been described in detail with respect to the preferred embodiment of the invention, it should be understood that a person having an ordinary skill in the art to which the present invention pertains can make various modifications and changes to the present invention without departing from the spirit and scope of the invention defined by the appended claims. Therefore, further modifications to the embodiment of the invention will fall within the scope of the invention.

The compatible system of digital rights management and the method for operating the same in accordance with the present invention has the effect of making contents efficiently compatible without exposing the interface between different digital rights management systems by transmitting first and second licenses for first and second apparatuses to the second apparatus connectable to a network, the first and second apparatuses being applicable to different digital rights management systems so that the first and second apparatuses can substantially use the same contents.

What is claimed is:

1. A compatible system of digital rights management, comprising:
a user server including a first authentication document transmitted from a first apparatus;
a second apparatus connected to the first apparatus and outputting a contents request signal and a second authentication document to reproduce substantially the same contents as the first apparatus; and
a provider server forming a virtual safe channel with the user server based on the contents request signal of the second apparatus to receive the first authentication document from the user server, and generating first and second licenses encrypted through respective first and second authentication documents to transmit the same to the second apparatus.

2. The system of claim 1, wherein the contents request signal contains information on the first apparatus and information on the contents selected from the second apparatus.

3. The system of claim 1, wherein the provider server verifies the user server having the first authentication document of the first apparatus based on the information on the first apparatus contained in the contents request signal and forms the virtual safe channel.

4. The system of claim 1, wherein the provider server encrypts the first license with an encryption key contained in the first authentication document and the second license with an encryption key contained in the second authentication document respectively.

5. The system of claim 4, wherein the first and second licenses are differently encrypted.

6. The system of claim 5, wherein the first and second apparatuses encodes the first and second licenses by encoding keys stored in the first and second apparatuses.

7. A method for operating a compatible system of digital rights management, comprising the steps of:
transmitting a second authentication document and a contents request signal to a provider server from a second apparatus via a network;
forming a virtual safe channel between a user server and the provider server based on the contents request signal;
transmitting a first authentication document of a first apparatus to the provider server from the user server via the virtual safe channel when the first authentication document of the first apparatus is requested by the provider server; and
generating first and second licenses in the provider server based on the first and second authentication documents and transmitting the first license and same contents to the first apparatus.

8. The method of claim 7, wherein in a case where the first and second apparatuses are connected to substantially reproduce the same contents, information on the first apparatus is contained in the contents request signal of the second apparatus.

9. The method of claim 7, wherein the first and second licenses are differently formed by encryption keys contained in the first and second authentication documents.

10. The method of claim 7, wherein the first and second licenses and contents are encoded by the respective encoding key stored in the first and second apparatuses.
